(19) United States
(12) Patent Application Publication
(10) Pub. No.: US 2012/0249369 A1
(43) Pub. Date: Oct. 4, 2012

(54) QUASI-COLD START SATELLITE VEHICLE SEARCH METHOD AND SYSTEM

(75) Inventor: Rayman Wai Pon, Cupertino, CA (US)

(73) Assignee: QUALCOMM Incorporated, San Diego, CA (US)

(21) Appl. No.: 13/244,088

(22) Filed: Sep. 23, 2011

Related U.S. Application Data
(60) Provisional application No. 61/422,902, filed on Dec. 14, 2010.

(51) Int. Cl. G01S 19/28

(52) U.S. Cl. 342/357.67

(57) ABSTRACT

Methods, systems, computer readable media, and mobile devices for searching for global navigation satellite system (GNSS) signals include acquiring satellite position location signals from a first SV in the GNSS from an Earth location. From an SV position list a determination is made whether any SVs in the GNSS are not-in-view of the first SV. Satellite position location signals are searched from other SVs in the GNSS, except from any SVs that have been determined not-in-view of the first SV. According to one aspect, ellipsoidal, additional, and extrapolated elimination regions are created to expand the SVs that can be eliminated as being not-in-view.

### CROSS-REFERENCE TO RELATED APPLICATIONS

This application claims the benefit under 35 U.S.C. §119(e) to U.S. Provisional Patent Application No. 61/422,902 entitled “Cold Start Satellite Vehicle Search”, filed Dec. 14, 2010, the disclosures of which are expressly incorporated herein by reference.

### FIELD

The present disclosure and various embodiments described herein relate in general to searching for satellite vehicles (SVs) in SV constellations, and more specifically to methods and apparatuses of searching for those SVs that are in view from at least one SV whose position is known.

### BACKGROUND

Instruments for providing accurate position information are becoming of widespread use. Examples include personal navigation devices (PNDs), mobile stations (MSs) or mobile devices, such as cellular telephones, personal communication system (PCS) devices, and other user equipment (UE).

Global navigation satellite systems (GNSSs) offer an approach to providing information from which position location information can be derived. A GNSS typically includes a constellation of SV-borne transmitters positioned to enable entities to determine their location on or above the Earth based on signals received from the SV-borne transmitters. In some applications, Earth-based transmitters may also be located on the Earth to transmit signals that may be used in conjunction with the signals from the SV-borne transmitters and from which an unknown position or location can be determined.

Current examples of such GNSSs include the Global Positioning System (GPS), Galileo, GLONASS, and Compass. In addition, a GNSS may include any combination of one or more different global or regional navigation satellite systems or augmentation systems, and the GNSS signals may include satellite positioning system (SPS) signals, GNSS-like, or other signals associated with such GNSS.

In addition to global positioning systems, currently a number of regional positioning systems have been deployed, as well. For example, the Quasi-Zenith Satellite System (QZSS) over Japan, the Indian Regional Navigational Satellite System (IRNSS) over India, and the Beidou system over China have been deployed. In addition, various augmentation systems, such as the Satellite Based Augmentation System (SBAS), may be enabled for use with one or more global or regional navigation satellite systems. For example, an SBAS may include an augmentation system that provides integrity information, differential corrections, or the like. Examples include the Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and the like.

These systems typically transmit a signal that is marked with a repeating pseudo-random noise (PN) code having a set number of chips. The PN code of each transmitter is distinguishable from PN codes from other transmitters, for example, using different PN codes for each SV, as in the GPS, or using the same code on different frequencies, as in the GLONASS system.

A user can derive precise navigation information including three-dimensional position, velocity, and time of day through information gained from a GNSS. For example, position measurements using the GPS are based on measurements of propagation delay times of GPS signals broadcast from the orbiting SVs to a GPS receiver. The precise capabilities of the GPS system are maintained using on-board atomic clocks for each SV, in conjunction with tracking stations that continuously monitor and correct SV clock and orbit parameters.

However, searching for and acquiring the GNSS signals takes some time, for a number of reasons. For example, during initial signal acquisition, the exact frequency of the signal from a particular SV is uncertain, due to the Doppler effect caused by relative movement between the SV and the receiver, and due to GPS clock reference errors in the local receiver. Data bit timing is also developed, after which a search for the code phase offset is performed within the window in which the PN code repeats. This is done by a trial and error method, and may take considerable time.

It can be seen that signal acquisition requires a great deal of time and resources. The GPS receiver needs to search across all SV PN sequences, all code phase hypotheses, and all Doppler frequency offsets in order to locate SV signals. For example, this may require searching 32 SVs, 1023 code hypotheses, and 10 kHz of frequency offset, or more. Examined sequentially, signal acquisition can take several minutes.

One method which has been used to reduce the signal acquisition time is to use parallel signal acquisition; however, this involves additional hardware, with higher costs, size, and power consumption. Another technique that has been used to reduce signal acquisition delay is to provide acquisition assistance (AA) information to aid a receiver in acquiring an SV signal. Such AA information permits a receiver to narrow the space that must be searched in order to locate a signal. This AA data generally comprises expected Doppler information, expected code phase information for each SV, and code phase and Doppler windows of fixed size in which the receiver is expected to search. However, Doppler values change with potential UE motion, which creates additional complications in acquiring the SV signals.

Nevertheless, even with AA data code phase and Doppler windows, the receiver may not always acquire the SV signal. This may occur because the SV signal is too weak or because the SV signal is corrupted due to noise. It is also possible that an AA data window is incorrectly located in time (code phase) or frequency.

Another way that has been used to reduce the time to search and acquire signals from GNSS SVs is to use information on time of day, approximate receiver location, and estimated SV positions. Using this information, a first pseudorange to a first SV is determined, and an approximate location of the receiver is determined. An estimated pseudorange for a second pseudorange to a second SV is determined from the approximate location and an SV position of the second SV. The receiver then searches for GNSS signals from the second SV in a range determined by the estimated pseudorange. This method reduces the initial search time to acquire GNSS signals from the second SV.

Still another way that has been used to reduce the time to search and acquire signals from GNSS SVs is to define a conditional visibility for each SV in which the conditional visibility is the possibility that if one SV is visible so is another SV. Through the use of conditional visibilities, searching weights for each SV are developed. And as more and more SVs are tried the confidence level in the conditional visibility of any particular SV increases. Thus, when choosing which SV to search next, the search can be focused on the most likely possibly visible SVs in order to reduce the time-to-first-fix (TTFF).

Once the signals from at least four SVs have been acquired and locked onto, the code phase measurements have been made, and a sufficient number of data bits (enough to determine the GPS timing reference and orbit parameters) are received a position calculation is made. A velocity calculation may be also undertaken if a sufficient number of Doppler measurements are available.

What is needed, therefore, is a method and apparatus for simplifying the techniques for searching and acquiring SV signals in order to reduce the time needed for SV search and acquisition.

### SUMMARY

Broadly described are techniques and systems for performing an SV search, which may be from a quasi-cold-start, as a part of an ongoing SV search process, or the like. Quasi-cold-start is used herein to mean starting an SV search in which the location of a user is not known or the user's position uncertainty (Punc) is large, and in which time and almanac, ephemeris, or rough satellite position information are known within predetermined resolutions. Time uncertainty (Tunc), for example, may be known with a resolution of seconds, tens of seconds, or a few minutes, and SV position may be obtained from almanac, ephemeris, or rough satellite position data that is aged, for example, by many weeks, weeks, or less.

One common case in which this situation (quasi-cold start) may arise is for a standalone GPS unit with no wireless WAN. In this case, after making fixes and then turning the receiver off for a day or more, typically recent almanac or SV orbit data may be available from some other means, and a real time clock is keeping rough time. But after a day or more, the position uncertainty, Punc, typically increases, especially to take into account for example, the case the user got on a plane or traveled to another location. Thus, the GPS unit one may not know where it is in the world. This is essentially the “quasi-cold state.” With a real time clock accuracy of 100 ppm, the time uncertainty grows to about 10 seconds after 1 day. After a week, the time uncertainty has grown to 1 minute. When the user turns on the GPS unit after such periods, the quasi-cold state would apply since the time uncertainty is many tens of seconds or minutes, the SV orbit data is somewhat fresh, and the user position is considered unknown.

As will become apparent, as the time and SV position uncertainties become larger, the uncertainty in the SV positions increases, and this may affect the not-in-view SV determination process. Hence, the time and SV position uncertainties can be as large as can be tolerated in the determination of a not-in-view SV. The meaning of “not-in-view” SVs is discussed in detail below.

Thus, described is a method for searching for GNSS signals including acquiring satellite position location signals from a first satellite vehicle SV in the GNSS from an Earth location. The method also includes determining from an SV position list whether any SVs in the GNSS are not-in-view of the first SV, and searching for satellite position location signals from other SVs in the GNSS, except from any SVs that have been determined not-in-view of the first SV.

Also described is method for searching for GNSS signals that includes acquiring satellite position location signals from a first SV in the GNSS from a location on or near the Earth, and determining from an SV position list whether any SVs in the GNSS are not-in-view of the first SV. The method also includes searching for satellite position location signals from other SVs in the GNSS, except from any SVs that have been determined to be not-in-view of the first SV and acquiring at least a course location of another SV from the acquired course location of the another SV. A determination is made from an SV position list whether any SVs in the GNSS are not-in-view of the another SV, and further acquisition searches are eliminated for SVs that are not-in-view of the another SV. The acquiring at least a course location of another SV and eliminating SVs that are not-in-view of the additional SV from further searches is repeated until at least a sufficient number of SVs have been acquired to make a position location determination.

Additionally described is a system for searching for GNSS signals that includes means for acquiring satellite position location signals from a first SV in the GNSS, means for determining from an SV position list whether any SVs in the GNSS are not-in-view of the first SV, and means for searching for satellite position location signals from other SVs in the GNSS, except from any SVs that have been determined not to be in view of the first SV.

A computer readable media is described that includes instructions for searching for GNSS signals which when executed by a processor cause the processor to acquire satellite position location signals from a first SV in the GNSS, determine from an SV position list whether any SV in the GNSS are not-in-view of the first SV, and search for satellite position location signals from other SVs in the GNSS, except from any SVs that have been determined not to be in view of the first SV.

Also described is a mobile device that includes a cellular telephone and a system for searching for GNSS signals. The system for searching for GNSS signals includes apparatus for acquiring satellite position location signals from a first SV in the GNSS, apparatus for determining from an SV position list whether any SVs in the GNSS are not-in-view of the first SV, and apparatus for searching for satellite position location signals from other SVs in the GNSS, except from any SVs that have been determined not to be in view of the first SV.

Additionally described is a method for searching for global navigation satellite vehicles (SVs). The method includes acquiring satellite position location signals from a first SV from an Earth location, determining whether any SVs are in a first ellipsoidal elimination region created by the first SV on a dark side of an SV orbit sphere, and searching for other SVs, except from any SVs that have been determined to be in the first ellipsoidal elimination region. The method also includes acquiring satellite position location signals from a second SV from an Earth location, determining whether any SVs are in a second ellipsoidal elimination region that is created by the second SV on the dark side of the SV orbit sphere and in a first additional elimination region between the first and second ellipsoidal elimination regions, and searching for satellite position location signals from other SVs, except from any SVs that have been determined to be in the first and second ellipsoidal elimination regions and the additional elimination region. The method may also include acquiring satellite position location signals from a third SV from an Earth location, determining from an SV position list whether any SVs are in a third ellipsoidal elimination region that is created by the third SV on the dark side of the SV orbit sphere, determining whether any SVs are in a second additional elimination region between the third and first ellipsoidal elimination regions and in a third additional elimination region between the third and second ellipsoidal elimination regions, determining whether any SVs are in an extrapolated elimination region that is between the first, second, and third ellipsoidal elimination regions and the first, second, and third additional elimination regions, and searching for other SVs, except for any SVs that have been determined to be in the first, second, third, ellipsoidal and additional elimination regions, and the extrapolated elimination region.

Also described is a system for searching for global navigation satellite system signals. The system includes means for acquiring satellite position location signals from a first satellite vehicle (SV), means for determining from an SV position list whether any SVs are in a first region that is not-in-view of the first SV, and means for searching for satellite position location signals from other SVs, except from any SVs that have been determined to be in the first region. The system also includes means for acquiring satellite position location signals from a second satellite vehicle (SV), means for determining from an SV position list whether any SVs are in a second region that is not-in-view of the second SV and in an extended region between the first and second regions, and means for searching for satellite position location signals from other SVs, except from any SVs that have been determined to be in the first, second, and extended regions. The system may also include means for acquiring satellite position location signals from another satellite vehicle (SV) from an Earth location, means for determining from an SV position list whether any SVs are in another region that is not-in-view of the another SV and in an extended not-in-view region between the first, second, and another regions, and means for searching for satellite position location signals from other SVs, except from any SVs that have been determined to be in the first, second, another, and extended regions.

Also described is a computer readable media including instructions for searching for global navigation satellite system signals. When the instructions are executed by a processor, they cause the processor to acquire satellite position location signals from a first SV, determine from an SV position list whether any SV is in a first region that is not-in-view of the first SV, and search for satellite position location signals from other SVs, except from any SVs that have been determined to be in the first region. The instructions also cause the processor to, from the search, acquire satellite position location signals from a second SV, determine from an SV position list whether any SV is in a second region that is not-in-view of the second SV and in an extended region between the first and second regions, and search for satellite position location signals from other SVs, except from any SVs that have been determined to be in the first, second, and extend regions. The instructions may also cause the processor to acquiring satellite position location signals from a third satellite vehicle (SV) from an Earth location, determine from an SV position list whether any SVs are in a third region that is not-in-view of the third SV and in an extended not-in-view region between the first, second, and third regions, and search for satellite position location signals from other SVs, except from any SVs that have been determined to be in the first, second, third, and extended regions.

Also described is a mobile device having a system for searching for global navigation satellite system signals. The system includes apparatus for acquiring satellite position location signals from a first satellite vehicle (SV), apparatus for determining from an SV position list whether any SVs are in a first region that is not-in-view of the first SV, and apparatus for searching for satellite position location signals from other SVs, except from any SVs that have been determined to be in the first region. The system also includes apparatus for acquiring satellite position location signals from a second satellite vehicle (SV), apparatus for determining from an SV position list whether any SVs are in a second region that is not-in-view of the second SV and in an extended region between the first and second regions, and apparatus for searching for satellite position location signals from other SVs, except from any SVs that have been determined to be in the first, second, and extended regions. The system may also include apparatus for acquiring satellite position location signals from another satellite vehicle (SV) from an Earth location, apparatus for determining from an SV position list whether any SVs are in another region that is not-in-view of the another SV and in an extended not-in-view region between the first, second, and another regions, and apparatus for searching for satellite position location signals from other SVs, except from any SVs that have been determined to be in the first, second, another, and extended regions.

Additionally disclosed is a method for searching for navigation satellite signals. The method includes acquiring satellite position location signals from at least first, second, and third satellite vehicles (SVs), determining ellipsoidal elimination regions on at least one orbit sphere on a dark side of the Earth from within which respective ones of which the at least first, second, and third SVs are not visible, determining additional elimination regions extending between respective pairs of the ellipsoidal elimination regions, determining an extrapolated elimination region encompassed by the additional elimination regions, determining if any non-acquired SVs are in the extrapolated elimination region, and searching for satellite position location signals from other SVs, except from any SVs that have been determined to be in the extrapolated elimination region.

Additionally disclosed is a computer readable media having instructions for searching for navigation satellite signals, which when executed by a processor cause the processor to acquire satellite position location signals from at least first, second, and third satellite vehicles (SVs), determine ellipsoidal elimination regions on at least one orbit sphere on a dark side of the Earth from within which respective ones of which the at least first, second, and third SVs are not visible, determine additional elimination regions extending between respective pairs of the ellipsoidal elimination regions, determine an extrapolated elimination region encompassed by the additional elimination regions, and determine if any non-acquired SVs are in the extrapolated elimination region. The instructions also cause the processor to search for satellite position location signals from other SVs, except from any SVs that have been determined to be in the extrapolated elimination region.

### BRIEF DESCRIPTION OF THE DRAWINGS

FIGS. 1-3 are perspective views illustrating a GNSS constellation and shadowed regions containing SVs not-in-view of sequentially acquired SVs.

FIG. 4 is a flow diagram of the method for searching and acquiring SVs.

FIG. 5 is a two-dimensional drawing illustrating a region in space showing an example for eliminating SVs that are not-in-view.

FIG. 6 is a two-dimensional drawing illustrating a region in space illustrating an example of two SVs that are above the horizon (zero degrees), for eliminating SVs that are not-in-view.

FIG. 7 is a graph showing a function of a sum of angles above a horizon of two SVs vs. distance separating the SVs in the same orbital sphere.

FIG. 8 is a three-dimensional view of a space around the Earth containing SVs in a GNSS system illustrating an example of the development of an additional elimination region after development of SV elimination regions for two SVs.

FIG. 9 is a flow diagram of a method for searching for satellites in a pair of ellipsoidal elimination regions joined by an additional elimination region.

FIG. 10 is a three-dimensional view of the SV system of FIG. 8, showing an example of a geometric technique for determining the additional elimination region between two ellipsoidal elimination regions.

FIG. 11 is a three-dimensional view of a space around the Earth containing SVs in a GNSS system illustrating an example of the development of an extrapolated elimination region after development of additional and ellipsoidal elimination regions for three SVs.

FIG. 12 is a flow diagram illustrating an example of one technique for determining whether any particular SV is inside any of the elimination regions for three SVs.

FIG. 13 is a flow diagram illustrating an example of one technique for determining whether a non-acquired SV is on the same side of the plane as the other ellipsoidal elimination regions (or condensed points representing the ellipsoidal elimination regions) in a polygon-shaped extrapolated elimination region.

FIG. 14 is a two-dimensional view comparing areas of ellipsoidal elimination regions, additional elimination regions, and extrapolated elimination regions.

FIG. 15 is an illustration in 3D space illustrating one technique for determining whether a non-acquired SV is on a side of a plane to be within an extrapolated elimination region.

And FIG. 16 is a diagram of an example hardware environment that may be used in conjunction with the techniques described herein.

In the various figures of the drawing, like reference numbers are used to denote like or similar parts.

### DETAILED DESCRIPTION

Broadly, the present disclosure includes a method for accelerating a search and acquisition of global navigation satellite system (GNSS) signals includes acquiring satellite-positioning signals from a first satellite vehicle (SV) in the GNSS. The method also includes determining whether any SVs in the GNSS constellations are not-in-view of the first SV from a list of SV positions, such as SV positions that may be obtained from SV almanac data, ephemeris data, or other SV position data, such as extended orbital data, or the like. The method then includes searching for satellite position location signals from other SVs in the GNSS, excluding any SVs that have been determined not to be in view of the first SV. The SV almanac data, for example, may include coarse location and status information for each SV in the constellation, an ionospheric model, and information to relate GPS derived time to Coordinated Universal Time (UTC).

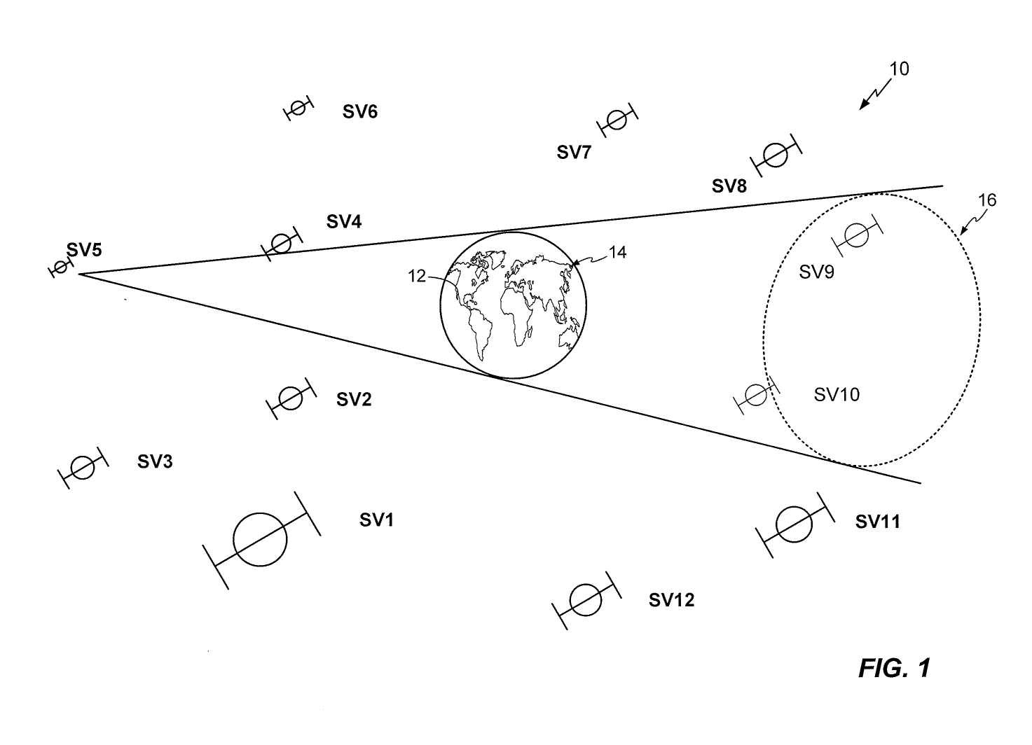

The concept of at least one embodiment of the method is illustrated in FIGS. 1-3, to which reference is now made. In FIG. 1, a perspective view illustrating a region of space 10 containing a GNSS constellation, which includes for example, a number of SVs, designated by SV1-SV12. Although 12 SVs are shown, the actual number may vary depending upon the particular GNSS under consideration. In fact, as mentioned above, it may be possible to rely upon GNSS signals from different GNSS systems, possibly including ground-based signals.

A user may have user equipment (UE) 12 located on the Earth 14, initially at an unknown location, for example, on the ground, in the air, or on the water at a location at which GNSS signals can be received. The GNSS signals are received and processed by the UE 12 that is equipped with a position location determining capability. The UE may include, for example, standalone position location equipment, such as that installed on vehicles, aircraft, ships, or the like. The UE may also include cellular or other wireless communication devices, personal communication system (PCS) devices, personal navigation devices (PNDs), personal information managers (PIMs), personal digital assistants (PDAs), laptop computers, or another suitable mobile device that is capable of receiving or processing navigation signals.

The UE may also include devices that communicate with such position location equipment, such as by short-range wireless, infrared, wireline connection, or other connection, regardless of whether SV signal reception, assistance data reception, or position-related processing occurs at the device or at the position location equipment.

When the UE 12 is first turned on, GNSS signals are first acquired from a first SV in a usual manner. In the embodiment shown in FIG. 1, the first SV acquired is shown as being, for example, SV5. Using geometric or other techniques, described in greater detail below, in conjunction with SV almanac data, ephemeris data, or other satellite position data, such as extended orbital data, or the like, the SVs that are not-in-view of the first SV acquired, SV5, are determined. Thus, when a first SV, in this example, SV5, has been acquired, it can be used as a reference SV, and other SVs not-in-view of the reference SV can be eliminated from further searches. There is no requirement that the position, of the UE 12 be known.

Therefore, in FIG. 1, SVs labeled SV9 and SV10 are within the shadow 16 of the Earth with respect to the GNSS signals transmitted from SV5, and are therefore not-in-view of SV5. SVs labeled SV9 and SV 10 are then eliminated from any further searches for GNSS SVs. It should be noted that in the embodiment illustrated, only two SVs have been eliminated on the first iteration, but in practice, the number of SVs not-in-view may vary greatly depending on the location of the reference SV. Nevertheless, the elimination of the SVs not-in-view reduces the number of SVs in the set of possible available SVs, reducing the search time necessary to search for and acquire signals from additional SVs.

After the signals from the reference SV, SV5 in the example of FIG. 1, have been acquired and the SVs that are not-in-view of SV5 have been eliminated from further searches, a search is conducted in a usual manner for signals from additional SVs that have not been excluded as being not-in-view. Thus, as shown in FIG. 2, SV labeled SV2, for example, is located. Using the same techniques as applied with respect to SV5, above, SVs labeled SV7, SV8, SV9, and SV10 are found to be not-in-view of SV2, and are eliminated from future GNSS SV searches.

As shown in FIG. 3, an SV search is illustrated in which SV7, SV8, SV9, and SV10 have been eliminated from the set of SV candidates. In the search illustrated in FIG. 3, SV 11, for example, is acquired, and SV4 and SV6 in the shadow 20 of the Earth 14 with respect to the GNSS signals from SV11 are eliminated from further searches. The process may be continued until all of the visible SVs from the UE 12 location are acquired.

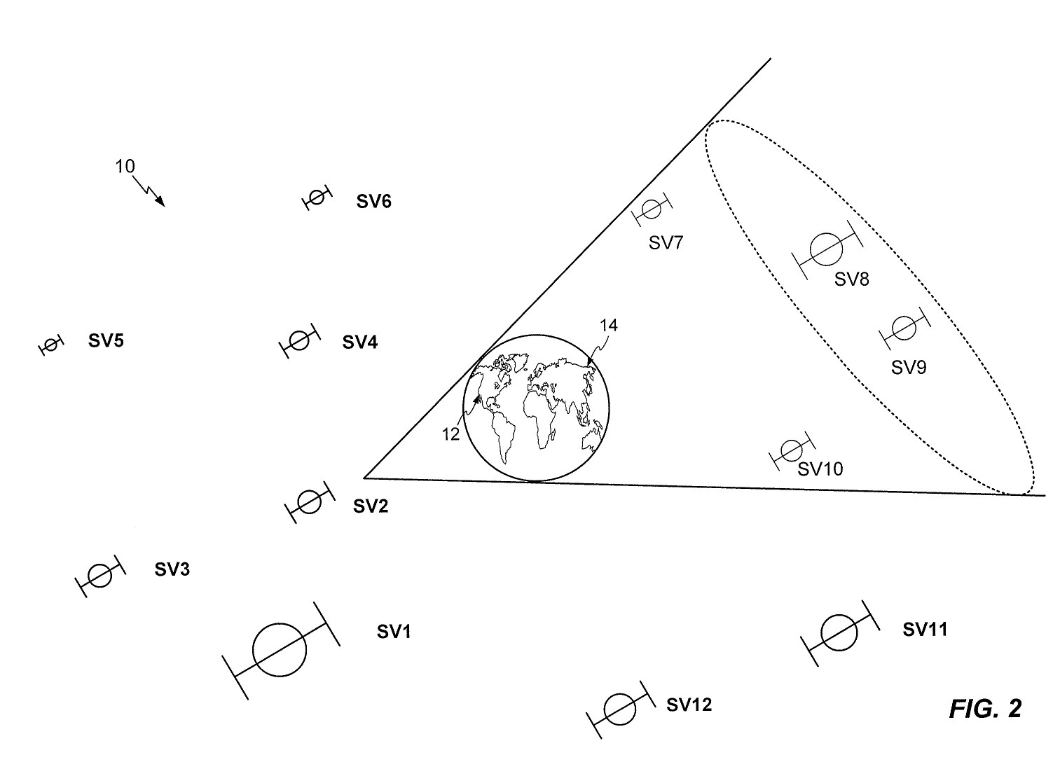

The broad method is illustrated in the flowchart 40 of FIG. 4, to which reference is now made. The method illustrated in FIG. 4 may, for example, be performed by a processor 130 executing program instructions 142 contained in a memory 132, or the like (see FIG. 16). From a quasi-cold-start, or other start at which no or little information is known about the user position on or near the Earth, oval 42, a first, or reference, SV is acquired, in usual manner, box 44. From SV almanac data, ephemeris data, or other satellite position data, such as extended orbital data, or the like, a position of an additional SV is determined, box 46. Using techniques described herein, a determination is made, box 48, whether the additional SV is not-in-view of the reference SV.

If the additional SV is found to be not-in-view of the reference SV, diamond 50, it is excluded from the set of GNSS SVs that can be used for position searching and location, box 54. After the not-in-view SV has been excluded from the searchable SV set, the determination is made whether more SVs are to be determined to be not-in-view, diamond 52. On the other hand, if the additional SV is not determined to be not-in-view, diamond 50, a determination is made, diamond 52, whether more SVs are available to make the not-in-view determination.

If additional SVSs are found to be available for not-in-view determination in diamond 52, the process is iterated to determine not-in-view SVs, returning to box 46 to determine a position of an SV in addition to the initial reference SV. The search order can be arranged to search in the order from smallest distance to largest distance.

On the other hand, if no SVs are found to be available for not-in-view determination in diamond 52 a determination is made in diamond 56 whether all of the SVs have been acquired. If not, the entire process will be iterated, returning to box 44. Here, however, a new reference SV will be searched for using the SV set from which the not-in-view SV have been eliminated. If all SVs are determined to have been acquired in diamond 56, the process is done, oval 58.

It will be appreciated that each time an SV acquisition is attained and SVs are eliminated from the set of SV candidates yet available to be acquired, the speed of the searches increases. Therefore, since attempted searches need not be conducted to find eliminated SVs, the overall time that is required for the user to determine his position is reduced.

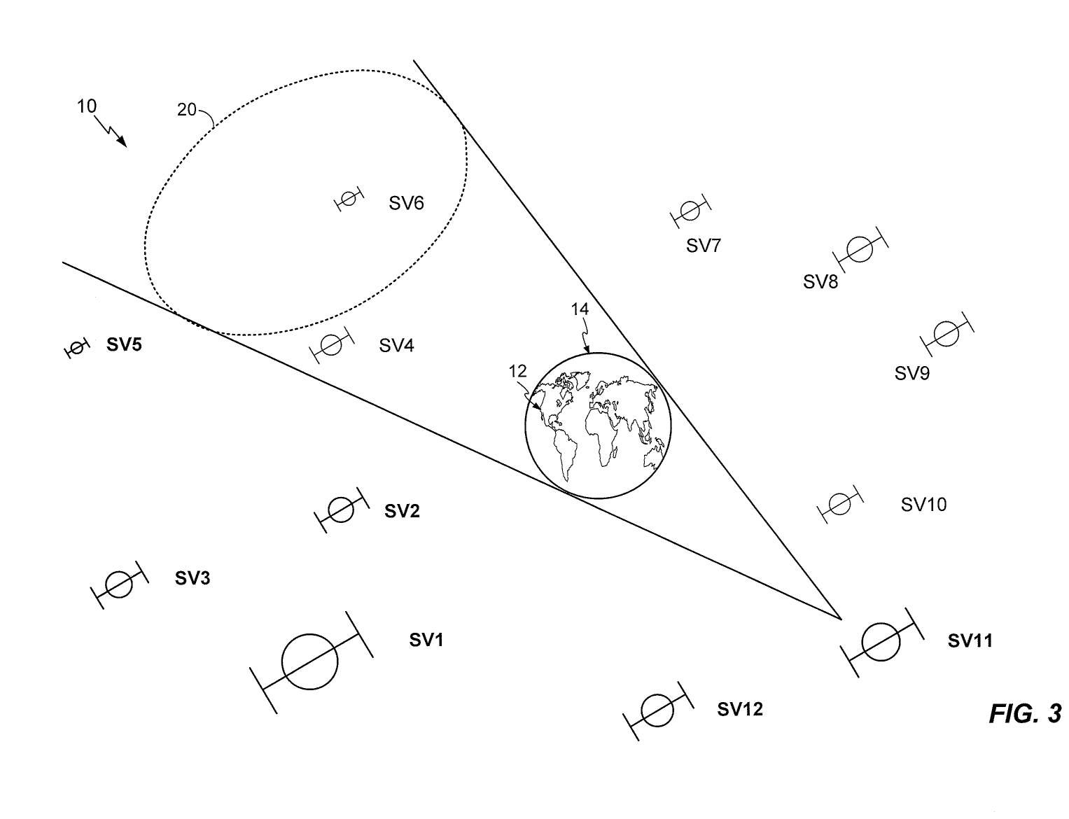

More specifically, with reference to FIG. 5, a two-dimensional drawing illustrating an elimination of not-in-view SVs. In FIG. 5, a region of space 60 is shown, with the UE 12 located on the surface of the Earth 14. Two lines 62 and 64 are drawn tangent to the Earth 14 from a first SV 66 in an orbit 68 and extending past their intersections with the Earth 11 and 13, ending at the other side of the circle defining the SV orbit 68. In three-dimensional space, the locus of tangent lines that intersect the Earth from the SV 66 forms a cone with SV 66 at the apex, and the intersection with the Earth 14 is a circle represented by the line 15. Any SVs in the SV elimination region 70 which do not have a direct line of sight to the first, or reference, SV 66 are then not visible to the UE 12, or any other UE on the ellipsoidal region 17 of the Earth above the line/circle 15 in the direction of the SV 66. The SVs in the SV elimination region 70 must have an elevation angle that is less than zero degrees for the UE 12 and any other UEs on the ellipsoidal region 17.

There are a number of techniques by which not-in-view SVs, can be determined, examples of which include, but are not limited to, the “piercing the Earth” technique, the distance measuring technique, and the “additional and extrapolated elimination regions” technique, as next described.

### The “Piercing the Earth” Technique

With reference again to FIG. 5, with a first, or reference, SV 66 acquired, the visibility of a second SV can be determined by the “piercing the Earth” technique. If a line 69 drawn between the first SV 66 and a second SV 71 pierces the Earth 14 at any point, then the two SVs are not visible to each other because their line of sight is blocked by the Earth. More importantly, the second SV 71 is not visible to the UE 12 that acquired the first SV 66 and any other UEs on the ellipsoidal region 17. However, if the line 69 does not pierce the Earth 14, then the second SV 71 may be visible to the UE 12 and any other UEs on the ellipsoidal region 17. “Piercing the Earth” means that the line joining the two SVs in question goes through the Earth. A tangent line only touches the surface of the Earth, and does not go through it.

Mathematically, assume the first SV 66 is located in a conventional Earth-centered, Earth-fixed (ECEF) terrestrial coordinate system, with coordinates (x1, y1, z1), and the second SV 71 is located with ECEF coordinates (x2, y2, z2), and the Earth, with a radius r, is located with its center with ECEF coordinates (0, 0, 0). Given that the UE 12 has acquired and hence can see the first, reference, SV 66, then the second SV 71 is not visible to the UE 12 (that is, it is below zero degrees elevation) if the following is true:

[(x2−x1)(x1)+(y2−y1)(y1)+(z2−z1)(z1)]²>[(x2−x1)²+(y2−y1)²+(z2−z1)²][x1²+y1²+z1²−r²]

For computation purposes, note that the second product term on the right hand side of the inequality check is based only on the first, reference, SV 66. A single calculation of this term is needed, which can then be re-used for assessment for all other SVs to determine their respective visibilities. Further, note that the component (x1²+y1^{2+z}1²) in the second term on the right represents the square of the orbit radius of the reference SV, referenced to the center of the Earth, and is nominally a constant for all SVs in a particular GNSS constellation. However, the actual x,y,z values may be used for better accuracy, and to match the values of x,y,z used in the other components of the inequality check.

### The Distance Comparison Technique

Mathematically, to determine SVs in the SV elimination region 70, it is assumed that all SVs are in orbit on roughly the same sphere. It should be noted, however, that this assumption is not necessarily a requirement. For example, the orbits of all SVs in a single GNSS system are typically on a single sphere, but in the case of SVs selected across different GNSS systems, the spheres may be of different radii. Nevertheless, the distance measuring technique still works, since the sphere radii of the different GNSS systems are known.

Continuing to refer to FIG. 5, all of the SVs for which the distance from the reference SV 66 is greater than the distance of tangent lines 62 or 64, the distance of 62 and 64 being equal, are in the SV elimination region 70, assuming orbits of all of the SVs are on the same sphere. Tangent line 62 or 64 is a line from SV 66 to the other side of the sphere containing the SV orbits, and tangent to the Earth 14.

The distance of tangent lines 62 or 64 can be computed as:

distance=2^{r}\sqrt{ρ^{z}−1}

where r=Earth radius
and

$$ρ = \frac{SV Orbit radius}{r}$$

The same concept can be extended to three dimensions in which the geometrical shape that results is a cone containing the Earth 14 and delineating the visible and non-visible SV regions with respect to the first SV 66, as can be seen from FIGS. 1-3. Any SV in the region inside of the cone in the direction of the reference SV 66 is visible to the UEs on the ellipsoidal region 17, and any SVs inside the cone in the direction away from the first SV 66 from line 15 are not visible to the UEs on the ellipsoidal region 17. Any SV in the region outside of the cone may be visible to the UEs on the ellipsoidal region 17.

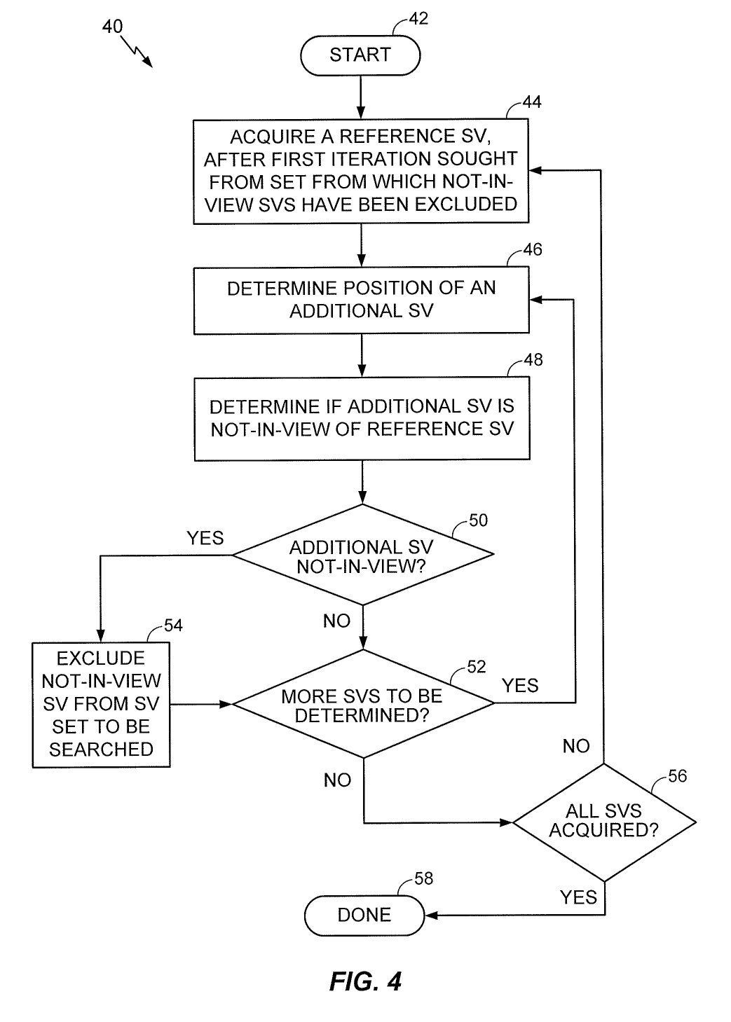

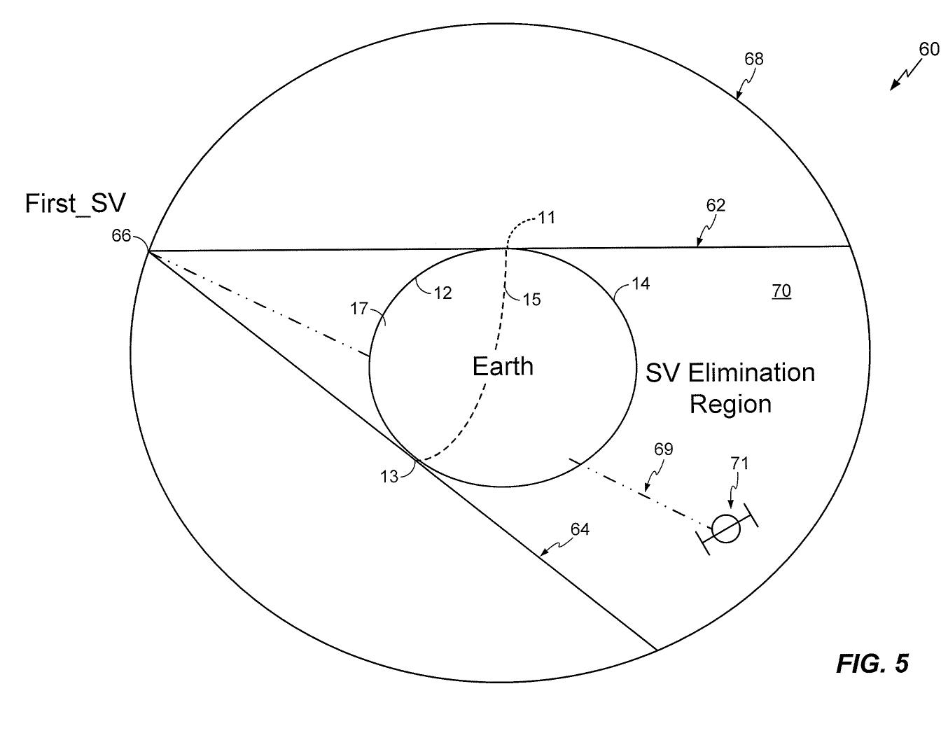

In practice, the first SV that is acquired may have an elevation higher than zero degrees, with respect to the actual user position. In addition, in practice, the SVs below five degrees, for example, may not be particularly useful because they are low on the horizon and may be blocked by buildings or trees. This is shown in FIG. 6, to which reference is now made. In FIG. 6, the first SV 66′ is located at an elevation θ above the horizon, and a second SV 73 is located at an elevation of β above the horizon. This widens the SV elimination region, as illustrated in the graph of FIG. 7, to which reference is now made, because the distance above which SVs are considered to be in the elimination region, is being reduced. The curve 75 in the graph of FIG. 7 shows distance between the unknown SVs and the known SV as a function of θ+β.

distance=2r cos α{−sin α+\sqrt{sin^{z} α+(ρ^{z}−1)}}

where

$$α = \frac{θ + β}{2} and ρ = \frac{SV orbit radius}{r}$$

For reference: GPS SV orbit radius≈26.57×10⁶ m, diameter (2r)≈53.14×10⁶ m.

It can be seen that the higher the SV elevations, and therefore, the higher the sum of θ+β, and the smaller the limit distance, which widens the SV elimination region.

It should be noted that there is no dependence on the user position. In fact, the user position could be completely unknown, as in cold starts. All that is needed is rough SV position knowledge from SV almanac data, ephemeris data, or other SV position data, such as extended orbital data, or the like, and time with a desired accuracy, as explained above.

With (x,y,z) SV positions at the desired reference time, which is adequate for multiple minutes, the distance calculation becomes simple. The square root can be omitted, and the squared distances can be compared against the square of the limit distance of graph 75 or similar. In comparing squared distances, only multiplies and adds can be employed. For SVs beyond the desired distance based on α, those SVs can be eliminated from the search, since they would likely not be visible anyway. This check is applied as each SV is acquired, saving search resources for other potentially visible SVs.

Since these techniques do not depend on the user's position, and work for time good to minutes with SV almanac data, ephemeris data, and other SV position data, such as extended orbital data, or the like, the techniques can be particularly useful in the common cold start case, with or without Country Code aiding. The techniques may also be useful in cold start applications with a pre-loaded almanac, with rough or accurate time. One example of this is a cold start while camped on a CDMA network. In this case, a UE is able to obtain accurate absolute GPS time with an accuracy of typically tens of microseconds from the CDMA network, since the CDMA base stations are synchronized to GPS time. And since many UE devices also employ a pre-loaded recent almanac, the techniques described here can be employed.

Another advantage of the techniques described above, is that they work for GNSS systems in addition to GPS, such as GLONASS, or the like. In addition, they work across GNSS systems, such as GPS to GLONASS or vice versa, by taking into account the different orbit radii. In such cases, the user would need to develop a table similar to that of FIG. 7 for use in normalizing the various SV orbit radii.

Another point to note is that the θ and β elevation angles shown in FIG. 6 can be incorporated into the “pierce the Earth technique” also by finding the new Earth radius that is tangent to the new line between the SVs at the θ and β angles, whether the SVs are orbiting on the same sphere or not. That new Earth radius would replace the one used in the equation above. Then any line connecting the two SVs in question that pierces this new adjusted Earth radius would imply the SV is in the newly defined elimination region.

The techniques described above can be extended to a method for determining a search order given two or more acquired SVs. This can be done by summing the computed distance to acquired SVs and selecting smallest summed distances of remaining SV candidates not in the not-in-view list for the search order. If desired, separation angle can be easily obtained from separation distance, since there is a one-on-one mapping between the two, potentially with a simple table lookup, which can use a squared distance, saving a square root operation.

The techniques described above work for time uncertainties up to two minutes, or more. The elevation change rate is about 8.5×10⁻³ degrees per second at zero degrees elevation for GPS. Elevations around zero degree elevation are focused on because it is here where the determination of visible or non-visible status is most affected by small errors in SV position estimates or accuracy of the time estimate. To change by one degree requires 117 seconds. If the first detected reference SV is at the horizon, and the second SV is near the opposite horizon, there could be an error in true visibility of the second SV due to the time accuracy or accuracy of the SV position data. That is, given the actual time or satellite positions, the second SV could be either above or below the horizon. However, even if there is an error in being either above or below the horizon, there is a small probability that the second SV can be acquired, since it is at the horizon and may be blocked by buildings, mountains, trees, or other obstructions. More likely, the first acquired SV (the reference SV) will be multiple degrees or more above the horizon. In this case, the one degree, or so, error due to Tunc of 2 minutes is not an issue, since the second SV would be below the horizon in actuality if the above inequality is met.

### The “Additional and Extrapolated Elimination Regions” Technique

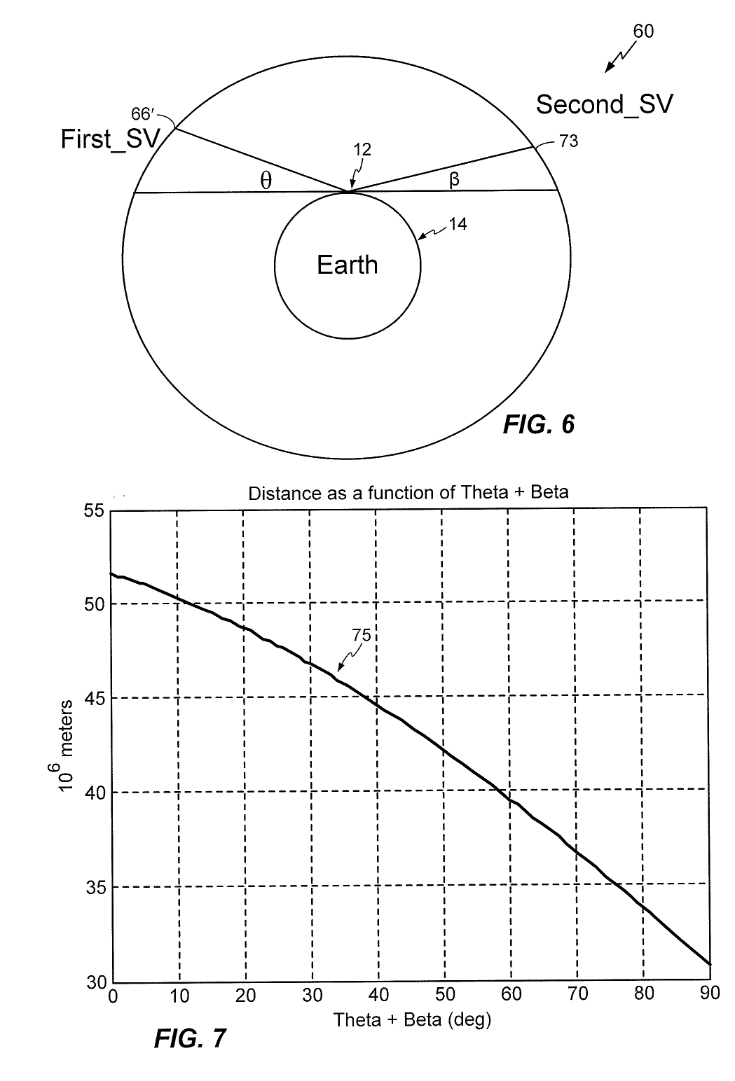

Examples of the “additional and extrapolated elimination regions” technique is explained in conjunction with FIGS. 8 through 10 to which reference is now made. As shown in FIG. 8, a region at 80 of space is located in a conventional Earth-centered, Earth-fixed (ECEF) terrestrial coordinate system, with x, y, and z-axes as shown.

The region of space 80 surrounds the Earth 14, and contains a number of SVs of one or more GNSS systems. In the example shown, the SVs in the space 80 are within a single GNSS system and have the same orbit radii; however, the additional and extrapolated elimination regions technique can be applied to SVs in different GNSS systems, as well. Thus, each of the SVs of the GNSS are contained on a sphere 82 at radius rₛ from the center of the Earth 14.

In the example shown, position location signals from first SV, SVA, are first found. SVA is shown in FIG. 8 as being located on the in-view side of the Earth 14, for illustration. For convenience, the side of the Earth from which position location signals can be acquired from SVs is referred to as the “in-view” side of the Earth 14. Also, the surface of the orbital sphere 82 in which in-view SVs may exist is referred to as the “in-view” surface of the orbital sphere 82.

The projection of the signals from SVA to the dark side of the Earth 14 defines an ellipsoidal elimination region 84 on the dark side of the SV orbital sphere 82. For convenience, the side of the Earth 14 opposite the in-view side of the Earth 14 is referred to as the “dark side” of the Earth 14. Also, the surface of the orbital sphere 82 in which in-view SVs do not exist (or in which not-in-view SVs exist) is referred to as the “dark side” of the surface of the orbital sphere 82. Thus, in accordance with the techniques described above, the SVs in the ellipsoidal elimination region 84, such as SVW, are eliminated from further searching.

Subsequently, using, for example, techniques described above, a search is conducted for additional SVs, with SVW having been eliminated from the search. In the illustration in FIG. 8, SVB, is found on the in-view side of the Earth 14. This defines another ellipsoidal elimination region 86 on the dark side of the SV orbital sphere 82. The SVs in the ellipsoidal elimination region 86, such as SVX, are then eliminated from further searching. It is noted that in general, the two ellipsoidal elimination regions 86 and 84 do not overlap.

With the second SV, SVB, acquired, the ellipsoidal elimination regions 84 and 86 can be extended beyond their boundaries. Given that the user has acquired, and therefore is able to see both SVA and SVB, then any SV on the orbital sphere 82 which lies on an arc 88 that joins SVA and SVB will also be visible to the user. This can be considered as if imaginary SVs on this arc have been acquired.

Therefore, an additional elimination region 90 between the ellipsoidal elimination regions 84 and 86 can be constructed to include the imaginary ellipsoidal elimination regions that would be created by all the imaginary SVs that lie on arc 88. Thus, the total elimination region can be increased to include a region 90 on the dark side of the orbital sphere 82. The region 90, which is roughly a rectangle with rounded edges on the shorter sides of the rectangle, is referred to herein as an “additional elimination region.” Depending on the separation angle between SVA and SVB, the additional elimination region 90 may increase to several times that of just the sum of the SVA and SVB ellipsoidal elimination regions 86 and 84. The additional elimination region 90 may, for example, contain additional SVs, such as SVY and SVZ, that can be eliminated from further SV searches.

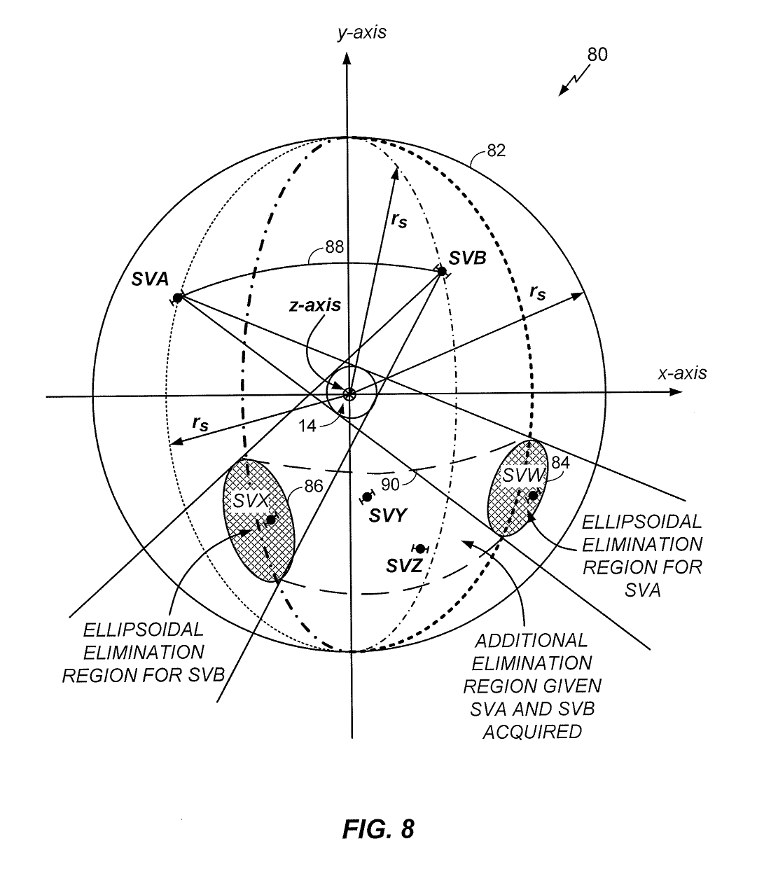

A flow diagram 91 of a method for searching for global navigation satellite system signals is shown in FIG. 9, to which reference is now made. As shown, satellite position location signals are acquired from a first satellite vehicle (SV) from an Earth location, box 95. After the first SV has been acquired, a determination is made whether any SVs are in a first ellipsoidal elimination region that is created by the first SV, box 97. Then, a search is made for satellite position location signals from other SVs, except from any SVs that have been determined to be in the first ellipsoidal region, box 99. Using techniques, such as those described above, satellite position location signals from a second SV are acquired from an Earth location, box 101. A determination is then made to locate any SVs that may be in the second ellipsoidal elimination region that created by the second SV.

An additional elimination region is then defined between the first and second ellipsoidal elimination regions, box 103, for example, by constructing an arc joining the first and second SVs and constructing the additional elimination region as if imaginary SVs existed on the arc to generate imaginary ellipsoidal elimination regions on the dark side of the orbital sphere, box 105.

Finally a search is conducted to search for satellite position location signals from other SVs, except from any SVs that have been determined to be in the first and second ellipsoidal elimination regions and the additional elimination region, box 107.

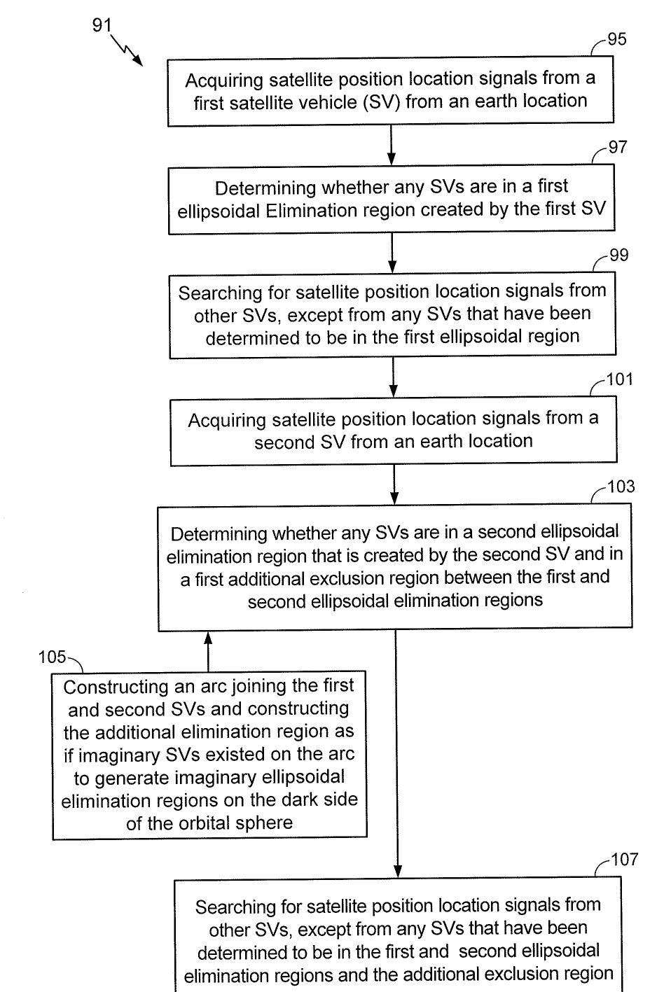

Geometrically, an example of one way this can be done is illustrated in FIG. 10. In the 3D space 80, all SVs in the GNSS constellation are rotated from the original coordinate system to a new coordinate system. In the new coordinate system, a plane 93 can be constructed containing the two acquired SVs, SVA and SVB and the center of the Earth 14. As an example, both SVA and SVB in the new coordinate system have their z coordinate equal to 0. Also, in the new coordinate system, one coordinate is made identical. For instance, the x coordinate of SVA and SVB is some negative value, and the same value. Finally, the last coordinate, y, has a value which is opposite in sign between SVA and SVB. We have simply rotated so the angle of the two SVs from the x-axis are identical. These rotations can be done for any two SVs acquired by a user.

Given this, the additional elimination region 90 is on the positive side of the x-axis, and has a surface region that has z values up to the radius of the ellipsoidal elimination regions 84 or 86, rₑₑᵣ. The y values are between the ellipsoidal elimination regions 84 and 86 in this new coordinate system, extending between −y+rₑₑᵣ and +y−rₑₑᵣ. The positive x-values of the additional elimination region 90 between the ellipsoidal elimination regions 84 and 86 (which are the same) extend up to the x-value of a corresponding ellipsoidal elimination region of an imaginary SV in the new coordinate system lying on the arc 88 in the negative x-axis on the orbital sphere 82.

Since the SVs in the GNSS system are on the orbital sphere 82, the rectangular box which encompasses these minimum and maximum x, y, and z values can be found, and any SVs in the new coordinate system inside this box is in the additional elimination region 90. Polar coordinates to find the elimination region can also be used. For instance, one polar coordinate could represent the 2D plane containing x and y, to indicate the angle from a reference axis (such as the x-axis), having a range between 0 and ±180 degrees. The other polar coordinate could represent the z-axis, having a range between 0 to ±90 degrees.

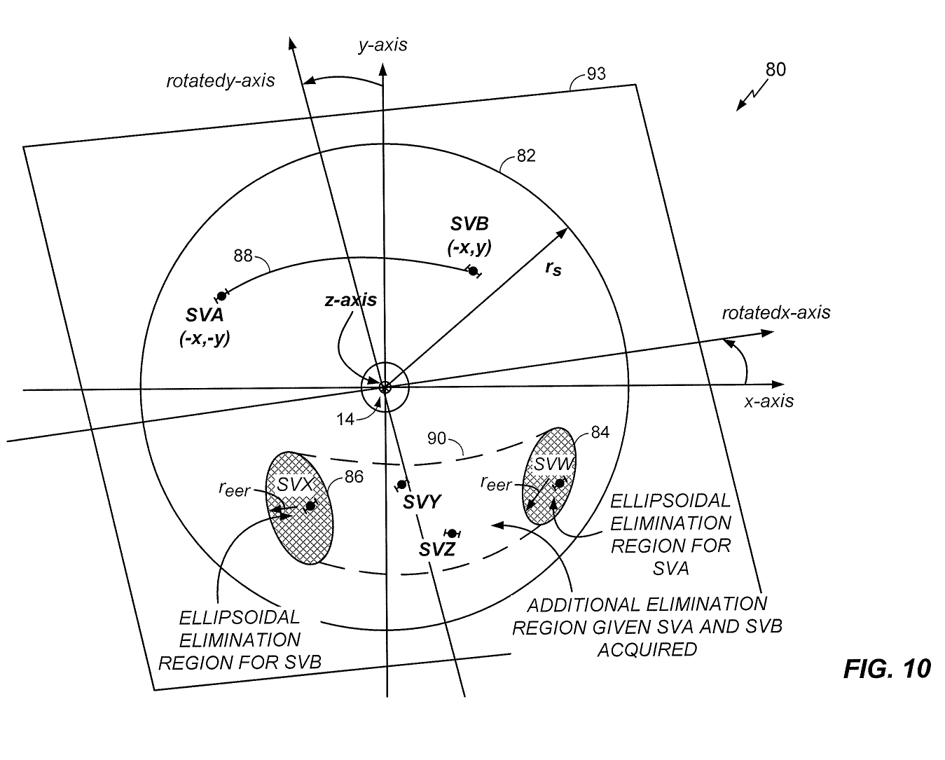

An example of a technique in which three SVs are acquired is shown in FIG. 11. The third SV that is acquired in the illustrated exemplary embodiment is SVC on the in-view side of the Earth 14, and its ellipsoidal elimination region 92 is on the dark side of the orbit sphere 82. In the illustrated example, no SVs are located in the ellipsoidal elimination region 92 for SVC.

With the third acquired SV, SVC, additional elimination regions 94 and 96 of rectangular shape are defined by including those regions respectively between ellipsoidal elimination regions 84 and 92 in a manner similar to that described above with respect to additional elimination region 90 between ellipsoidal elimination regions 84 and 86. The additional elimination region 94 may, for example, eliminate SVV within its perimeter from further searches. In this example, no SVs are located in the additional elimination region 96.

In addition, however, the surface region 100 that is enclosed by additional elimination regions 90, 94, and 96 may be an additional part of the total elimination region. The surface region 100, now referred to as the extrapolated elimination region 100, is of triangular shape on the SV orbit sphere 82 in the FIG. 11 embodiment, and encompasses SVU, which can also be eliminated from further SV searches. The extrapolated elimination region 100 significantly extends the total elimination region from that of only the ellipsoidal elimination regions 84, 86, and 92 and the additional elimination regions 90, 94, and 96, as described below further in detail.

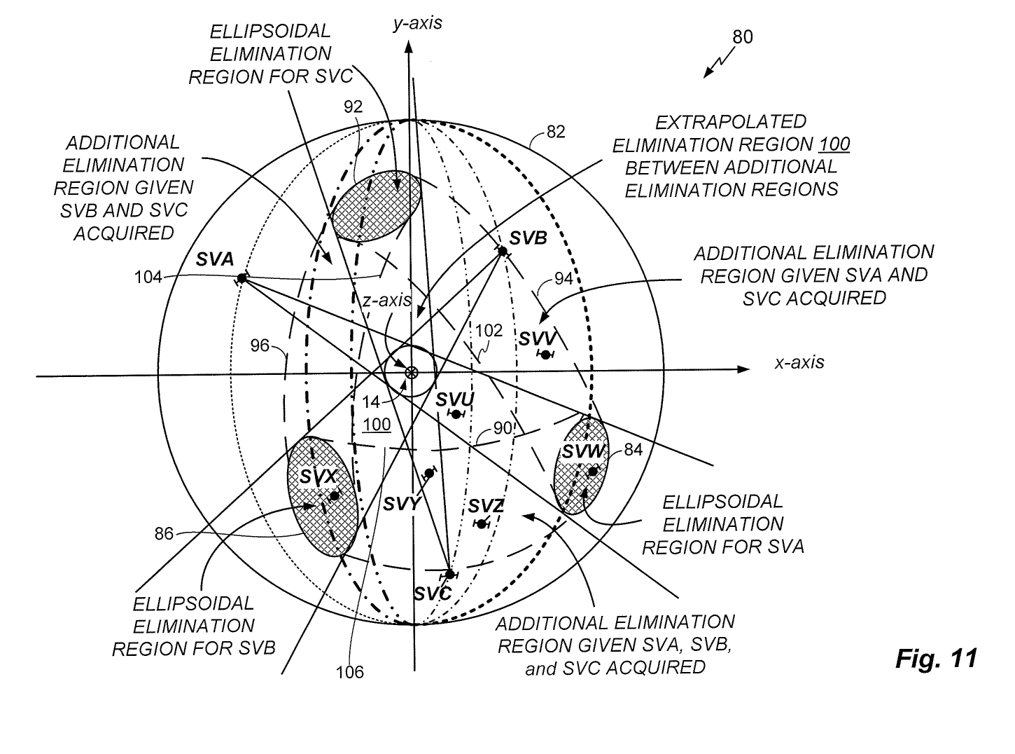

An example of one technique for determining whether any particular SV is inside any of the elimination regions for three SVs is shown in the flow diagram 121 in FIG. 12. Once three SVs are acquired, a three-part check is performed. First, a check is made to determine if any of the non-acquired SVs are in an ellipsoidal elimination region using the distance or piercing the Earth method, described above. This is done for each of the three acquired SVs, box 123. Second, using the rectangular box or polar coordinate method described above, after rotation, a check is made to determine if non-acquired SVs are in within the additional elimination region. This is done for each of the three pairs of ellipsoidal elimination regions, box 125. Third, a check is made to determine if any of the remaining non-acquired SVs are in the extrapolated elimination region, box 127.

With reference again to FIG. 11, in order to determine whether any of the remaining non-acquired SV are in the extrapolated elimination region 100, it can be observed that the extrapolated elimination region 100 on the surface of the SV orbit sphere 82 is a combination of three arcs 102, 104, and 106. A plane may be defined which includes an arc between the centers of the ellipsoidal elimination regions 84 and 92 and the center of the Earth 14. For the initial arc, the plane will divide the Earth 14 into two equal halves. If any non-acquired SV is on the same side of the plane as the ellipsoidal elimination region 86, then the non-acquired SV may be in the extrapolated elimination region 100.

A second test is performed on a second arc, for example an arc between the centers of the ellipsoidal elimination regions 86 and 92 in the extrapolated elimination region 100, and a check is made to determine if any non-acquired SVs are on the same side as the ellipsoidal elimination region 84. Finally, a similar process is performed for an arc between the centers of the ellipsoidal elimination regions 84 and 86 to determine if any non-acquired SVs are on the same side as the ellipsoidal elimination region 92. Any non-acquired SVs which is found to be on the same side as the remaining ellipsoidal elimination region 92 that was also found for the first two tests can be regarded as being inside the elimination region 100.

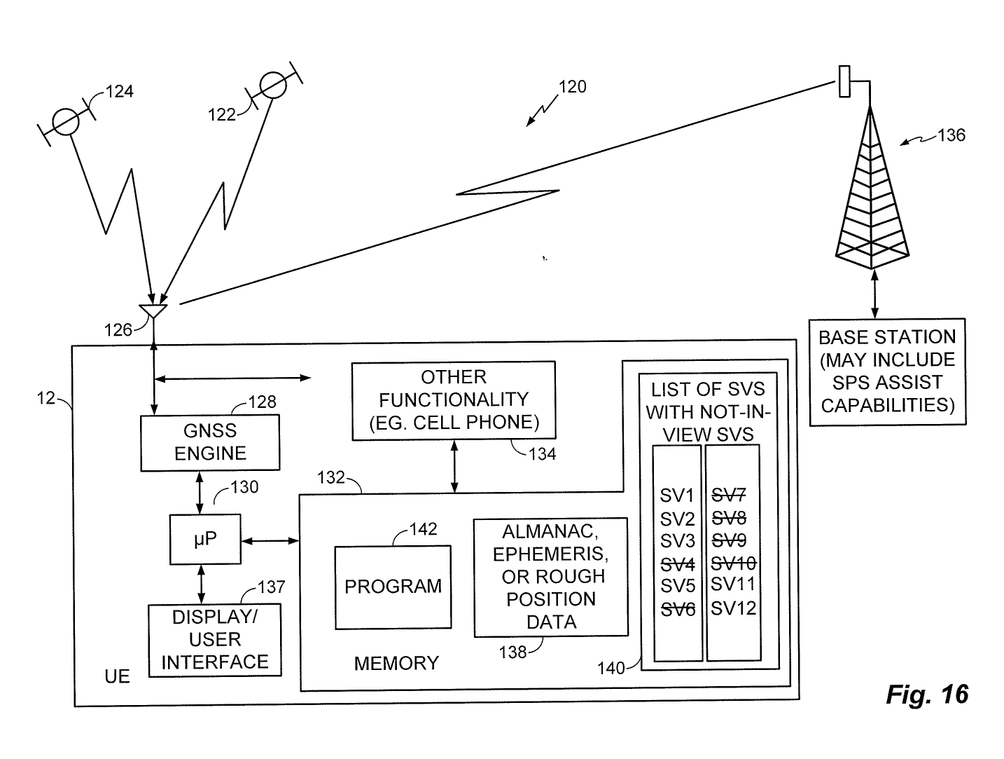

One technique for determining whether a non-acquired SV is on the side of a plane 151 constructed between the respective centers of the ellipsoidal elimination regions is illustrated in FIG. 15, to which reference is now additionally made.

The standard equation of a plane in 3 space is:

Ax+By+Cz+D=0

Given three points in space (x1,y1,z1), (x2,y2,z2), (x3,y3,z3) the equation of the plane through these points is given by the following determinants.

$$A = \vert \begin{matrix}1 & {y}_{1} & {z}_{1} \\ 1 & {y}_{2} & {z}_{2} \\ 1 & {y}_{3} & {z}_{3}\end{matrix} \vert B = \vert \begin{matrix}{x}_{1} & 1 & {z}_{1} \\ {x}_{2} & 1 & {z}_{2} \\ {x}_{3} & 1 & {z}_{3}\end{matrix} \vert$$

$$C = \vert \begin{matrix}{x}_{1} & {y}_{1} & 1 \\ {x}_{2} & {y}_{2} & 1 \\ {x}_{3} & {y}_{3} & 1\end{matrix} \vert D = - \vert \begin{matrix}{x}_{1} & {y}_{1} & {z}_{1} \\ {x}_{2} & {y}_{2} & {z}_{2} \\ {x}_{3} & {y}_{3} & {z}_{3}\end{matrix} \vert$$

Expanding the above gives

A=y₁(z₂−z₃)+y₂(z₃−z₁)+y₃(z₁−z₂)

B=z₁(x₂−x₃)+z₂(x₃−x₁)+z₃(x₁−x₂)

C=x₁(y₂−y₃)+x₂(y₃−y₁)+x₃(y₁−y₂)

−D=x₁(y₂z₃−y₃z₂)+x₂(y₃z₁−y₁z₃)+x₃(y₁z₂−y₂z₁)

The sign of s=Ax+By+Cz+D determines which side the point (x,y,z) lies with respect to the plane. If s>0 then the point lies on the same side as the normal (A,B,C). If s<0 then it lies on the opposite side, if s=0 then the point (x,y,z) lies on the plane.

These techniques can be extended easily to four or more acquired SVs, where a polygon region on the surface of the orbit sphere 82 forms the extrapolated elimination region. For N acquired SVs, there will be N plane tests to perform (unless some of the N acquired SVs are inside the polygon formed from other acquired SVs). For each plane test, all remaining ellipsoidal elimination regions in the polygon of the extrapolated elimination region are on one side of the plane. The non-acquired SV being tested must be on the same side of the plane as those respective opposite ellipsoidal elimination regions, and again, a non-acquired SV can be regarded as being in the elimination region if it is on the same side of the plane as the remaining polygon ellipsoidal elimination regions, for all N plane tests. This method also works directly for SVs in other GNSS systems irrespective of their orbit radius because this plane method considers all orbit radii since the plane goes on to infinity.

It should be noted that the tests in the example outlined above have been explained in terms of testing to determine if a non-acquired SV is on the same side as other ellipsoidal elimination regions; however, other tests may be equally advantageously employed. For example, the tests may be conducted with respect to other additional elimination region edges, or points contained within one or more of the ellipsoidal elimination regions. For example, to simplify the calculations that may be required, the ellipsoidal elimination regions each can be condensed to a single point that would result if a line were drawn from the SV that creates its corresponding ellipsoidal elimination region through the center of the Earth to the orbit sphere 82 on the dark side of the Earth. The tests described, therefore, need only be conducted with respect to the resulting point where the line intersects the orbit sphere 82, rather than with respect to the entire ellipsoidal elimination region. In addition, although the extrapolated elimination region has been described as having sides that are essentially collinear with the inside edges of the additional elimination regions, for ease of computation, they may be regarded as having edges that are collinear with lines extending between the center points of respective pairs of ellipsoidal elimination regions, as described in greater detail below.

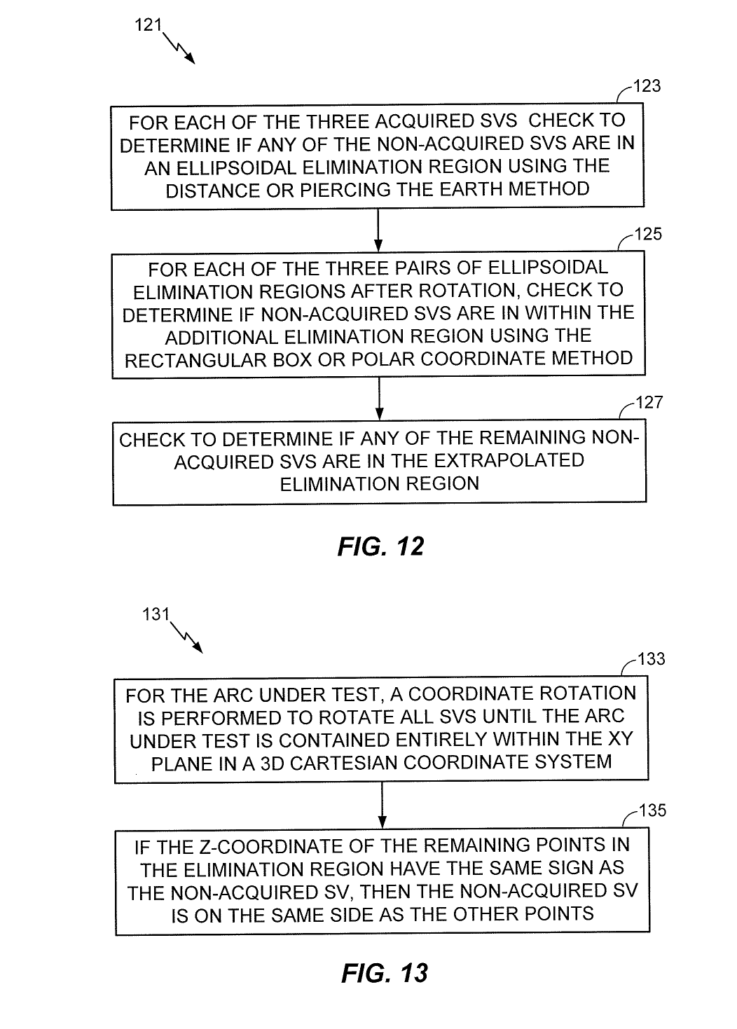

In order to determine whether a non-acquired SV is on the same side of the plane as the other ellipsoidal elimination regions (or condensed points representing the ellipsoidal elimination regions) in a polygon-shaped extrapolated elimination region, a test may be performed, as shown in the flow diagram 131 in FIG. 13, to which reference is now made. For the arc under test, a coordinate rotation may be performed until the arc under test is contained entirely within the xy plane in a 3D Cartesian coordinate system. All SVs are rotated together, box 133. Basically, if the z-coordinate of the remaining condensed points in the elimination region have the same sign as the non-acquired SV, then the non-acquired SV is on the same side as the other condensed points, box 135.

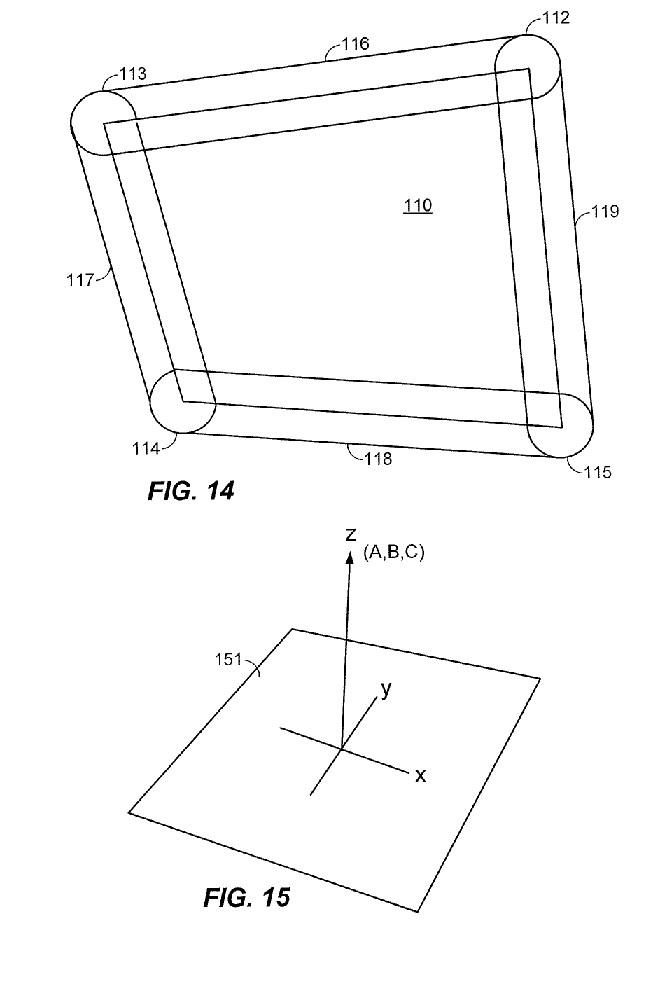

When three or more SVs are obtained, in general, the extrapolated elimination region is much larger than combined area of the ellipsoidal elimination regions and the additional elimination regions. This can be seen from the 2D illustration of FIG. 14, to which reference is now made. To reduce the number of required calculations, and increase the SV acquisition speed, one could perform only the test to determine if non-acquired SVs are in the extrapolated elimination region 110 and lose only a small percentage of the total area. The area being lost may include, for example only a portion of the areas of the ellipsoidal elimination regions 112-115 and a portion of the additional elimination regions 116-119.

A diagram of an exemplary environment or system 120 including various components that may be used in conjunction with the techniques described herein is shown in FIG. 16, to which reference is now made. The UE 12 receives position location signals from GNSS SVs 122 and 124 in a conventional manner via antenna 126. The UE 12 includes a GNSS engine 128 for processing the position location signals, again in conventional manner.

A microprocessor 130 is shown, in this example, separately from the GNSS engine 128; however, the microprocessor 130 may be incorporated as a part of the GNSS engine 128. Although a microprocessor 130 has been disclosed, its functions may be performed by other processing devices, such a computer, an array of logic elements, a processor, a microcontroller, a finite state machine, or the like.

A memory 132 communicates with the microprocessor 130 and contains program code and data for use by the microprocessor 130 and the GNSS engine 128. As used herein the term “memory” refers to any type of long term, short term, volatile, nonvolatile, or other storage devices and is not to be limited to any particular type of memory or number of memories, or type of media upon which information is stored. By way of illustration, the memory 132 may be realized, for example, by a writeable memory, such as RAM memory, FRAM memory, or the like, in combination with flash memory, ROM memory, EPROM memory, EEPROM memory, registers, hard disk, a removable disk, a CD-ROM, or any other form of storage medium known in the art.

In the embodiment shown, the memory 132 is coupled to the microprocessor 130 so that the microprocessor 130 can read information from, and write information to, the memory 132. Alternatively, the memory 132 may be integral to the microprocessor 130. The microprocessor 130 and the memory 132 may reside in an ASIC, which may, in turn, reside in a mobile device or mobile station, base station, or base station controller. In the alternative, the microprocessor 130 and the memory 132 may reside as discrete components in a mobile device (as shown), base station, or base station controller.

As suggested above, in some applications, other functionality, such as cellphone functionality 134, may be provided. The cellphone functionality 134, for example, may communicate with a base station 136, which may provide GNSS assisting capabilities, as well as communication capabilities.

A display or other user interface 137 is provided to enable the UE 12 to interface with a user (not shown). The user interface 137 may be, for example, a display, which may be a character display, segment display, bit mapped display, indicators, or the like, a speaker or other transducer, an electrical connection for coupling electrical signals to a corresponding user device, or any other suitable way to communicate information from the UE 12 to a user or user device.

In operation, the memory 132 may have memory locations that contain SV almanac data, ephemeris data, or other SV position data, such as extended orbital data, or the like 138, as well as a list 140 that contains the list of SVs from which the not-in-view SVs have been excluded. In the example illustrated, for example, SV4, SV6, SV7, SV8, SV9, and SV10 have been excluded from the list of SVs to be searched and acquired, in accordance to the example described above with reference to FIGS. 1-3. The memory 132 may also have memory locations that contain a program or program code 142 to perform the steps of various methods or techniques described herein, for example, as outlined in FIG. 4, FIG. 9, FIG. 12, and FIG. 13, etc.

The memory 132 may also contain program instructions or program code to cause the microprocessor or processor to perform the various functions outlined above to determine the ellipsoidal elimination regions, the additional regions, and the extrapolated region, as well as the calculations necessary to identify whether any SV is within any or all of these elimination regions.

If desired, once all of the SVs in the list 140 have been searched that have not been eliminated as being not-in-view, the SVs that have been eliminated as being not-in-view may be searched for completeness. This may be desirable, for example, if the satellite position information from the ephemeris, almanac, or rough satellite position is outdated, or is otherwise incorrect. For instance, if an SV reposition has occurred between the time the almanac satellite position information was obtained by the receiver and the current time, then the SV may be incorrectly in the not-in-view list, but actually may be in view.

The techniques methodologies described herein can be implemented in various other ways depending upon the applications. For example, these techniques can be implemented in hardware, firmware, software, or a combination thereof. For a hardware implementation, the processing units can be implemented within one or more application specific integrated circuits (ASICs), digital signal processors (DSPS), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination thereof.

For a firmware or software implementation, the techniques can be implemented with modules (e.g., procedures, functions, and so on) that perform the functions described herein. Any machine-readable medium tangibly embodying instructions can be used in implementing the techniques described herein. For example, software codes can be stored in a memory and executed by a processing unit.

If implemented in firmware, software, or a combination thereof, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions, data, or both may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

It should be appreciated that the techniques described herein can be used by themselves, or can be combined with other, known techniques designed to speed up the search and acquisition of SV signals. Moreover, the techniques described herein can be extended to situations in which time in unknown, if needed. Finally, for the sake of completeness, if desired, after all SVs have been acquired using the techniques described herein, a search may be made of the non-acquired SVs.

Although the invention has been described and illustrated with a certain degree of particularity, it should be understood that the present disclosure has been made by way of examples only, and that numerous changes in the combination and arrangement of parts may be resorted to without departing from the spirit and scope of the invention, as hereinafter claimed.

1. A method for searching for global navigation satellite system (GNSS) signals, comprising:
acquiring satellite position location signals from a first satellite vehicle (SV) in said GNSS from an Earth location;
determining from an SV position list whether any SVs in said GNSS are not-in-view of said first SV; and
searching for satellite position location signals from other SVs in said GNSS, except from any SVs that have been determined not-in-view of said first SV.

2. The method of claim 1 wherein said determining whether any SVs in said GNSS are not-in-view of said first SV comprises determining whether any SVs are hidden from view of said first SV by the Earth.

3. The method of claim 1 wherein said determining whether any SVs in said GNSS are not-in-view of said first SV comprises determining if a line between said first SV and another SV in said SV position list pierces the Earth.

4. The method of claim 1 further comprising acquiring at least a coarse location of a second SV and eliminating from further searches SVs that are not-in-view of said second SV.

5. The method of claim 4 further comprising repeating said acquiring for additional SVs and eliminating SVs that are not-in-view of said additional SVs from further searches until at least a sufficient number of SVs have been acquired to make a position location determination of said Earth location.

6. The method of claim 5 wherein at least one of said additional SVs is in different satellite positioning systems.

7. The method of claim 5 wherein all of said additional SVs are a same satellite positioning system.

8. The method of claim 5 wherein said repeating and acquiring is repeated until all SVs that are not-in-view have been eliminated.

9. The method of claim 1 wherein said determining whether any SVs in said GNSS are not-in-view of said first SV comprises determining a region on an opposite side of the Earth that is not visible from said first SV and identifying SVs in said region.

10. The method of claim 1 wherein said position list is derived from SV almanac data.

11. The method of claim 1 wherein said position list is derived from SV ephemeris data.

12. The method of claim 1 wherein said position list is derived from SV position data.

13. The method of claim 1 further comprising deriving said position list from data received from said first SV.

14. A method for searching for global navigation satellite system (GNSS) signals, comprising:
acquiring satellite position location signals from a first satellite vehicle (SV) in said GNSS from an Earth location;
determining from an SV position list whether any SVs in said GNSS are not-in-view of said first SV;
searching for satellite position location signals from other SVs in said GNSS, except from any SVs that have been determined not to be in view of said first SV;
acquiring at least a coarse location of another SV;
determining from an SV position list whether any SVs in said GNSS are not-in-view of said another SV;
eliminating from further searches SVs that are not-in-view of said another SV; and
repeating said acquiring at least a coarse location for an additional SV and eliminating SVs that are not-in-view of said additional SV from further searches until at least a sufficient number of SVs have been acquired to make a position location determination.

15. The method of claim 14 wherein said acquiring at least a coarse location of another SV comprises assuming that all SVs are in orbit on roughly the same sphere.

16. The method of claim 14 wherein said determining from an SV position list whether another SV in said GNSS is not-in-view of said first SV comprises determining that a distance between said first and second SVs is greater than a distance from said first SV to an orbit distance of said SVs along a line between said first SV and said orbit distance.

17. The method of claim 16 wherein said line is tangent to the Earth.

18. The method of claim 16 wherein said line extends from said first SV to a point at said orbit distance located a predetermined angle away from a line tangent to the Earth between said first SV and said orbit distance.

19. The method of claim 14 wherein said determining whether any SV in said GNSS are not-in-view of said first SV comprises determining whether any SVs are hidden from view of said first SV by the Earth.

20. The method of claim 14 wherein said determining whether any SVs in said GNSS are not-in-view of said first SV comprises determining a region on an opposite side of the Earth that is not visible from said first SV and identifying SVs in said region.

21. The method of claim 14 wherein said determining whether any SVs in said GNSS are not-in-view of said first SV comprises determining if a line between said first SV and another SV in said SV position list pierces the Earth.

22. The method of claim 14 wherein at least one of said additional SVs are located in different satellite positioning systems.

23. The method of claim 14 wherein all of said additional SVs are located in a same satellite positioning system.

24. The method of claim 14 wherein said position list is derived from SV almanac data.

25. The method of claim 14 wherein said position list is derived from SV ephemeris data.

26. The method of claim 14 wherein said position list is derived from at least rough SV position data.

27. The method of claim 14 further comprising deriving said position list from data received from said first SV.

28. A system for searching for global navigation satellite system (GNSS) signals, comprising:
means for acquiring satellite position location signals from a first satellite vehicle (SV) in said GNSS;
means for determining from an SV position list whether any SVs in said GNSS are not-in-view of said first SV; and
means for searching for satellite position location signals from other SVs in said GNSS, except from any SVs that have been determined not to be in view of said first SV.

29. The system of claim 28 wherein said means for determining whether any SVs in said GNSS are not-in-view of said first SV comprises means for determining whether any SVs are hidden from view of said first SV by the Earth.

30. The system of claim 28 further comprising means for acquiring at least a coarse location of a second SV and means for eliminating from further searches SVs that are not-in-view of said second SV.

31. The system of claim 28 wherein said means for determining whether any SVs in said GNSS are not-in-view of said first SV comprises means for determining a region on an opposite side of the Earth that is not visible from said first SV, means for identifying SVs in said region, and means for eliminating said identified SVs from further satellite positioning system signal searches.

32. The method of claim 28 wherein said means for determining whether any SVs in said GNSS are not-in-view of said first SV comprises means for determining if a line between said first SV and another SV in said SV position list pierces the Earth.

33. The system of claim 28 wherein said position list is derived from SV almanac data.

34. The system of claim 28 wherein said position list is derived from SV ephemeris data.

35. The system of claim 28 wherein said position list is derived from at least rough SV position data.

36. The system of claim 28 further comprising deriving said position list from data received from said first SV.

37. The system of claim 28 wherein at least some of said additional SVs are located in different satellite positioning systems.

38. The system of claim 28 wherein all of said additional SVs are located in a same satellite positioning system.

39. A non-transitory computer readable medium comprising:
instructions for searching for global navigation satellite system (GNSS) signals which when executed by a processor cause the processor to:
acquire satellite position location signals from a first SV in said GNSS;
determine from an SV position list whether any SV in said GNSS is not-in-view of said first SV; and
search for satellite position location signals from other SVs in said GNSS, except from any SVs that have been determined not to be in view of said first SV.

40. The non-transitory computer readable medium of claim 39 wherein said instructions for determining whether any SVs in said GNSS are not-in-view of said first SV comprise instructions for determining whether any SVs are hidden from view of said first SV by the Earth.

41. The non-transitory computer readable medium of claim 39 further comprising instructions for acquiring at least a coarse location of a second SV, and instructions for eliminating from further acquisition searches SVs that are not-in-view of said second SV.

42. The non-transitory computer readable medium of claim 39 wherein said program instructions for determining whether any SVs in said GNSS are not-in-view of said first SV comprise instructions for determining a region on an opposite side of the Earth that is not visible from said first SV, instructions for identifying SVs in said region, and instructions for eliminating said identified SVs from further satellite positioning system signal searches.

43. A mobile device for searching for searching global navigation satellite system (GNSS) signals comprising:
a memory; and
at least one processor coupled to said memory and configured to:
acquire satellite position location signals from a first satellite vehicle (SV) in said GNSS;
determine from an SV position list whether any SVs in said GNSS are not-in-view of said first SV; and
search for satellite position location signals from other SVs in said GNSS, except from any SVs that have been determined not to be in view of said first SV.

44. The mobile device of claim 43 wherein said at least one processor is further configured to determine whether any SVs in said GNSS are not-in-view of said first SV by determining whether any SVs are hidden from view of said first SV by the Earth.

45. The method of claim 43 wherein said at least one processor is further configured to determine whether any SVs in said GNSS are not-in-view of said first SV by determining if a line between said first SV and another SV in said SV position list pierces the Earth.

46. The mobile device of claim 43 wherein said at least one processor is further configured to acquire at least a coarse location of a second SV and eliminate from further searches SVs that are not-in-view of said second SV.

47. The mobile device of claim 43 wherein said at least one processor is further configured to determine whether any SVs in said GNSS are not-in-view of said first SV by determining a region on an opposite side of the Earth that is not visible from said first SV, identifying SVs in said region, and eliminating said identified SVs from further satellite positioning system signal searches.

48. The mobile device of claim 43 wherein said position list is derived from SV almanac data.

49. The mobile device of claim 43 wherein said position list is derived from SV ephemeris data.

50. The mobile device of claim 43 wherein said position list is derived from at least rough SV position data.

51. The mobile device of claim 43 wherein said position list is derived from data received from said first SV.

52. A method for determining a candidate SV search order, comprising:
acquiring a reference SV;
determining distances from candidate SVs to said reference SV; and
determining a search order for SV candidates based on said distances.

53. A method for determining a candidate SV search order, comprising;
acquiring at least two reference SVs;
determining distances from at least two candidate SVs to said at least two reference SVs;
for each candidate SV, summing said determined distances to said at least two reference SVs;
and determining a search order for said at least two candidate SVs based on said summed determined distances.

54. A method for searching for global navigation satellite vehicles (SVs), comprising:
a) acquiring satellite position location signals from a first SV from an Earth location;
b) determining whether any SVs are in a first ellipsoidal elimination region that is created by said first SV on a dark side of an SV orbit sphere;
c) searching for other SVs, except from any SVs that have been determined to be in said first ellipsoidal region;
d) acquiring satellite position location signals from a second SV from an Earth location;
e) determining whether any SVs are in a second ellipsoidal elimination region that is created by said second SV on said dark side of said SV orbit sphere and in a first additional elimination region between said first and second ellipsoidal elimination regions; and
f) searching for satellite position location signals from other SVs, except from any SVs that have been determined to be in said first and second ellipsoidal elimination regions and said additional elimination region.

55. The method of claim 54 further comprising:
g) acquiring satellite position location signals from a third SV from an Earth location;
h) determining from an SV position list whether any SVs are in a third ellipsoidal elimination region that is created by said third SV on said dark side of said SV orbit sphere;
i) determining whether any SVs are in a second additional elimination region between said third and first ellipsoidal elimination regions and in a third additional elimination region between said third and second ellipsoidal elimination regions;
j) determining whether any SVs are in an extrapolated elimination region that is between said first, second, and third ellipsoidal elimination regions and said first, second, and third additional elimination regions; and
k) searching for other SVs, except for any SVs that have been determined to be in said first, second, third, ellipsoidal and additional elimination regions, and said extrapolated elimination region.

56. The method of claim 55 further comprising repeating steps g) through k) until all SVs have been searched.

57. The method of claim 56 further comprising, after all SVs have been searched, searching for SVs that have been eliminated from searching.

58. The method of claim 54 wherein said determining whether a non-acquired SVs is in said first ellipsoidal elimination region comprises determining whether said non-acquired SV is hidden from view from said first SV by the Earth.

59. The method of claim 54 wherein said determining whether a non-acquired SV is in said first ellipsoidal elimination region comprises determining if a line between said first SV and said non-acquired SV pierces the Earth.

60. The method of claim 54 wherein said determining whether a non-acquired SV is in said second ellipsoidal elimination region comprises determining if a line between said second SV and said non-acquired SV pierces the Earth.

61. The method of claim 54 wherein said searching for satellite position location signals from other SVs comprises searching from a position list derived from SV almanac data.

62. The method of claim 54 wherein said searching for satellite position location signals from other SVs comprises searching from a position list derived from SV ephemeris data.

63. The method of claim 54 wherein said searching for satellite position location signals from other SVs comprises searching from a position list derived from SV position data.

64. The method of claim 63 further comprising deriving said position list from data received from said first SV.

65. A system for searching for global navigation satellite system signals, comprising:
means for acquiring satellite position location signals from a first satellite vehicle (SV);
means for determining from an SV position list whether any SVs are in a first region that is not-in-view of said first SV;
means for searching for satellite position location signals from other SVs, except from any SVs that have been determined to be in said first region;
means for acquiring satellite position location signals from a second satellite vehicle (SV);
means for determining from an SV position list whether any SVs are in a second region that is not-in-view of said second SV and in an extended region between said first and second regions; and
means for searching for satellite position location signals from other SVs, except from any SVs that have been determined to be in said first, second, and extended regions.

66. The system of claim 65 further comprising:
a) means for acquiring satellite position location signals from another satellite vehicle (SV) from an Earth location;
b) means for determining from an SV position list whether any SVs are in another region that is not-in-view of said another SV and in an extended not-in-view region between said first, second, and another regions; and
c) means for searching for satellite position location signals from other SVs, except from any SVs that have been determined to be in said first, second, another, and extended regions.

67. The system of claim 66 further comprising means for repeating steps a) through c) until all SVs have been searched.

68. The system of claim 67 further comprising means for searching for SVs that have been determined to be in a not-in-view region.

69. The system of claim 65 wherein said means for determining whether any SVs are in said first and second regions that are not-in-view of respective said first and second SVs comprises means for determining whether any SVs are hidden from view of said first and second SVs by the Earth.

70. The system of claim 65 wherein said means for determining whether any SVs in said first region that is not-in-view of said first SV comprises means for determining if a line between said first SV and another SV in said SV position list pierces the Earth.

71. The system of claim 65 wherein said means for determining whether any SVs in said second region that is not-in-view of said second SV comprises means for determining if a line between said second SV and another SV in said SV position list pierces the Earth.

72. The system of claim 65 wherein said position list is derived from SV almanac data.

73. The system of claim 65 wherein said position list is derived from SV ephemeris data.

74. The system of claim 65 wherein said position list is derived from SV position data.

75. The system of claim 65 further comprising means for deriving said position list from data received from said first SV.

76. A non-transitory computer readable medium comprising:
instructions for searching for global navigation satellite system signals which when executed by a processor cause the processor to:
acquire satellite position location signals from a first SV;
determine from an SV position list whether any SV is in a first region that is not-in-view of said first SV;
search for satellite position location signals from other SVs, except from any SVs that have been determined to be in said first region;
from said search, acquire satellite position location signals from a second SV;
determine from an SV position list whether any SV is in a second region that is not-in-view of said second SV and in an extended region between said first and second regions;
and search for satellite position location signals from other SVs, except from any SVs that have been determined to be in said first, second, and extended regions.

77. The non-transitory computer readable medium of claim 76 wherein said instructions for determining whether any SVs are in said first region comprise instructions for determining whether any SVs are hidden from view of said first SV by the Earth.

78. The non-transitory computer readable medium of claim 76 wherein said instructions for determining whether any SVs are in said second region comprise instructions for determining whether any SVs are hidden from view of said second SV by the Earth.

79. The non-transitory computer readable medium of claim 76 further comprising instructions for acquiring at least a coarse location of said second SV.

80. The non-transitory computer readable medium of claim 76 wherein said instructions for determining whether any SVs are in said first, and second regions comprise instructions for determining regions on a dark side of the Earth that are not visible from said first and second SVs, instructions for identifying SVs in said regions, and instructions for eliminating said identified SVs from further satellite positioning system signal searches.

81. The non-transitory computer readable medium of claim 76 further comprising instructions to cause the processor to:
acquire satellite position location signals from a third satellite vehicle (SV) from an Earth location;
determine from an SV position list whether any SVs are in a third region that is not-in-view of said third SV and in an extended not-in-view region between said first, second, and third regions; and
search for satellite position location signals from other SVs, except from any SVs that have been determined to be in said first, second, third, and extended regions.

82. A mobile device comprising:
a memory; and
at least one processor coupled to said memory and configured to:
acquire satellite position location signals from a first satellite vehicle (SV);
determine from an SV position list whether any SVs are in a first region that is not-in-view of said first SV;
search for satellite position location signals from other SVs, except from any SVs that have been determined to be in said first region; acquire satellite position location signals from a second satellite vehicle (SV);
determine from an SV position list whether any SVs are in a second region that is not-in-view of said second SV and in an extended region between said first and second regions; and
search for satellite position location signals from other SVs, except from any SVs that have been determined to be in said first, second, and extended regions.

83. The mobile device of claim 82 wherein said at least one processor is further configured to:
a) acquire satellite position location signals from another satellite vehicle (SV) from an Earth location;
b) determine from an SV position list whether any SVs are in another region that is not-in-view of said another SV and in an extended not-in-view region between said first, second, and another regions; and
c) search for satellite position location signals from other SVs, except from any SVs that have been determined to be in said first, second, another, and extended regions.

84. The mobile device of claim 83 wherein said processor is further configured to repeat steps a) through c) until all SVs have been searched.

85. The mobile device of claim 84 wherein said at least one processor is further configured to search for SVs that have been determined to be in a not-in-view region.

86. The mobile device of claim 82 wherein said at least one processor is further configured to determine whether any SVs are in said first and second regions that are not-in-view of respective said first and second SVs by determining whether any SVs are hidden from view of said first and second SVs by the Earth.

87. The mobile device of claim 82 wherein said at least one processor is further configured to determine whether any SVs in said first region that is not-in-view of said first SV by determining if a line between said first SV and another SV in said SV position list pierces the Earth.

88. The mobile device of claim 82 wherein said at least one processor is further configured to determine whether any SVs in said second region that is not-in-view of said second SV by determining if a line between said second SV and another SV in said SV position list pierces the Earth.

89. A method for searching for navigation satellite signals, comprising:
acquiring satellite position location signals from at least first, second, and third satellite vehicles (SVs);
determining ellipsoidal elimination regions on at least one orbit sphere on a dark side of the Earth from within which respective ones of which said at least first, second, and third SVs are not visible;
determining additional elimination regions extending between respective pairs of said ellipsoidal elimination regions;
determining an extrapolated elimination region encompassed by said additional elimination regions;
determining if any non-acquired SVs are in said extrapolated elimination region;
and searching for satellite position location signals from other SVs, except from any SVs that have been determined to be in said extrapolated elimination region.

90. The method of claim 89 wherein said determining if any non-acquired SVs are in said extrapolated elimination region comprises:
a) constructing a plane containing at least an edge of one said additional elimination regions and the center of the Earth;
b) determining if one of said non-acquired SVs is on a side of said plane in a direction of at least another edge of said extrapolated elimination region; and
c) repeating steps a) and b) for each of said additional elimination regions.

91. The method of claim 90 wherein said determining if one of said non-acquired SVs is on a side of said plane in a direction of at least another edge of said extrapolated elimination region comprises:
identifying a number of points at which lines from the acquired SVs through the center of the Earth pierce an orbital sphere; and
for each edge, constructing a rotated coordinate system wherein the edge under test is contained entirely within an xy plane in a 3D Cartesian coordinate system;
wherein if z-coordinates of the points have the same sign as said one of said non-acquired SVs, then said one of said non-acquired SVs is on said side of said plane in a direction of at least another edge of said extrapolated elimination region.

92. A non-transitory computer readable medium comprising:
instructions for searching for navigation satellite signals, which when executed by a processor cause the processor to:
acquire satellite position location signals from at least first, second, and third satellite vehicles (SVs);
determine ellipsoidal elimination regions on at least one orbit sphere on a dark side of the Earth from within which respective ones of which said at least first, second, and third SVs are not visible;
determine additional elimination regions extending between respective pairs of said ellipsoidal elimination regions;
determine an extrapolated elimination region encompassed by said additional elimination regions;
determine if any non-acquired SVs are in said extrapolated elimination region;
and search for satellite position location signals from other SVs, except from any SVs that have been determined to be in said extrapolated elimination region.

93. The non-transitory computer readable medium of claim 92 wherein said instructions to determine whether any non-acquired SVs are in said extrapolated elimination region comprise instructions to cause said processor to:
a) construct a plane containing an edge of one said additional elimination regions and the center of the Earth;
b) determine if one of said non-acquired SVs is on a side of said plane in a direction of at least another edge of said extrapolated elimination region; and
c) repeat steps instructions a. and b. for each other edges of said additional elimination regions.

94. The non-transitory computer readable medium of claim 93 wherein said instructions to determine if one of said non-acquired SVs is on a side of said plane in a direction of at least another edge of said extrapolated elimination region comprise instructions to cause said processor to:
identify a number of points at which lines from the acquired SVs through the center of the Earth pierce an orbital sphere; and
for each edge, construct a rotated coordinate system wherein the edge under test is contained entirely within an xy plane in a 3D Cartesian coordinate system;
wherein if z-coordinates of the points have the same sign as said one of said non-acquired SVs, then said one of said non-acquired SVs is on said side of said plane in a direction of at least another edge of said extrapolated elimination region.
